(19) United States
(12) Patent Application Publication
(10) Pub. No.: US 2024/0053027 A1
(43) Pub. Date: Feb. 15, 2024

(54) HOUSEHOLD APPLIANCE AND METHOD FOR ASSEMBLING A HOUSEHOLD APPLIANCE

(71) Applicant: ELECTROLUX APPLIANCES AKTIEBOLAG, Stockholm (SE)

(72) Inventors: Gerhard KLEIN, Rothenburg ob der Tauber (DE); Filippo MILANESI, Forli (IT); Alex VIROLI, Forli (IT); Daniele CASO, Forli (IT); Ulrich HÄUTLE, Rothenburg ob der Tauber (DE); Elisabeth REBELEIN, Rothenburg ob der Tauber (DE)

(21) Appl. No.: 18/267,628

(22) PCT Filed: Dec. 10, 2021
(86) PCT No.: PCT/EP2021/085128

§ 371 Date: Jun. 15, 2023

(30) Foreign Application Priority Data
Dec. 16, 2020 (EP) 20214653.6

(51) Int. Cl. F24C 15/10; H05B 6/12; H01R 4/48

(52) U.S. Cl. CPC F24C 15/108; H05B 6/1209; H01R 4/4863

(57) ABSTRACT

A household appliance (10) comprises a housing or an installation case (112), particularly a protection box. The household appliance (10) further comprises at least two of a consumer load (132, 232) for consumption of electrical power, a delivery system for delivery of electrical power to the at least one consumer load (132, 232), mains connection means for a connection of the household appliance (10) to the electric power supply, a control unit and/or an operating panel (20) for appliance control and/or for user interaction, and at least one connection means (144, 144′, 146, 146′, 258, 256, 260′) for electrical connection of the at least two of the consumer load (132, 232), the delivery system for electrical power, the mains connection means, and the control unit and/or the operating panel (20). The at least two of the consumer load (132, 232), the delivery system for electrical power, the mains connection means, and the control unit and/or the operating panel (20) are arranged or arrangeable within the housing or installation case (112) in superimposed levels. Furthermore, at least one of the consumer load (132, 232), the delivery system for electrical power, the mains connection means, and the control unit and/or the operating panel (20) comprises a first connection means (144, 144′, 258) for electrical connection, which is connectable to a second connection means (146, 146′, 260, 260′) for electrical connection in a connection movement, which points in the same direction as or complies with an assembly movement for assembling the at least one of the consumer load (132, 232), the delivery system for electrical power, the mains connection means, and the control unit and/or the operating panel (20) in the housing or installation case (112). Said second connection means (146, 146′, 260, 260′) is arranged or has been arranged in the housing or installation case (112).

The present invention relates to household appliance, particularly a cooking appliance, more particularly a cooking hob, even more particularly an induction cooking hob, comprising a housing or an installation case, at least two of
a consumer load for consumption of electrical power,
a delivery system for delivery of electrical power to the consumer load,
mains connection means for a connection of the household appliance to the electric power supply,
a control unit and/or an operating panel for appliance control and/or for user interaction,
   and at least one connection means for electrical connection of or between the at least two of the consumer load, the delivery system, the mains connection means and the control unit and/or the operating panel according to claim 1. Further, the present invention relates to a method for assembling a household appliance, according to claim 15.

Generally, household appliances are assembled from modular components, which may be individual parts, e.g. motors, heating elements, pumps, or the like, or systems or subsystems, which themselves may be an assembly of single parts, e.g. printed circuit boards like control units or user interfaces. A relevant number of said modular components is of electrical nature, which modular components have to be supplied with electrical energy and which are electrically connected with other electrical components for information and/or power transfer. In production facilities for household appliances, nowadays, there is already an advanced level of automation, which is reflected in an automated assembly of components, for example arrangeable in a housing of the household appliance. However, there are still manual assembly steps required for establishing electrical contacts, particularly by connecting plug contacts of wiring harnesses.

It is an object of the present invention to provide a household appliance, which is constructed in such a way that the level of automation in production facilities of household appliances can be further increased. It is a further object of the present invention to provide a method for assembling a household appliance, which supports an advanced level of automation during assembly of a household appliance.

The object is achieved by a household appliance comprising a housing or an installation case, at least two of
a consumer load for consumption of electrical power,
a delivery system for delivery of electrical power to the consumer load,
mains connection means for a connection of the household appliance to the electric power supply,
a control unit and/or an operating panel for appliance control and/or for user interaction,
   and at least one connection means for electrical connection of or between the at least two of the consumer load, the delivery system, the mains connection means and the control unit and/or the operating panel. Said at least two of the consumer load, the delivery system, the mains connection means and the control unit and/or the operating panel are arranged or arrangeable within the housing or the installation case in superimposed levels. Furthermore, at least one of, particularly each of, the consumer load, the delivery system for electrical power, the mains connection means and the control unit and/or the operating panel comprises a first connection means for electrical connection, which is connectable to a second connection means for electrical connection. The connection of first and second connection means is configured to take place in a connection movement, which points in the same direction as or complies with an assembly movement for assembling the at least one of the consumer load, the delivery system for electrical power, the mains connection means and the control unit and/or the operating panel in the housing or installation case. The second connection means is arranged or has been arranged in the housing or installation case, in particular prior to the connection movement performed on the first connection means and the at least one of the consumer load, the delivery system for electrical power, the mains connection means and the control unit and/or the operating panel, respectively. Said connection and/or assembly movement is particularly a single movement, for example an at least approximately linear movement in one direction.

More in detail, according to one aspect of the present invention, the intended increase of the level of automation is achieved by arrangement of at least two modules and/or components, particularly of printed circuit boards, in superimposed levels, i. e. at least one module and/or component arranged above another one. Such an arrangement may be a direct one or, alternatively, with interposition of a layer of any kind. This way of household appliance construction allows an automated assembling of a first module or component, e.g. in a top down assembly movement, particularly by means of an assembly robot, into a housing or an installation case, followed, especially directly followed or, alternatively, after said interposition of said layer, by an automated assembling of a second module or component above, particularly directly above or diagonally above, the first component into said housing or installation case. Moreover, according to another aspect of the present invention, the intended increase of the level of automation is achieved in that at least one of the consumer load, the delivery system for electrical power, the mains connection means and the control unit and/or the operating panel comprises a first connection means for electrical connection, which is connectable to a second connection means for electrical connection, arranged at a location separate from, and particularly not allocated to, said at least one of the consumer load, the delivery system for electrical power, the mains connection means, the control unit and/or the operating panel. Said second connection means may be arranged at or allocated to another one of the consumer load, the delivery system for electrical power, the mains connection means and the control unit and/or the operating panel or it may be arranged at a housing part and/or a frame or support part or element. Furthermore, the second connection means is arranged or has been arranged in the housing or installation case in a connection movement, which points in the same direction as or complies with an assembly movement for assembling the at least one of the consumer load, the delivery system for electrical power, the mains connection means, the control unit and/or the operating panel in the housing or installation case.

Anyone or at least one of said assembly movements and/or said connection movement is or are preferably established by means of an assembly robot, which may be executed mainly in a direction at least approximately orthogonally to a base area or a reference area of the housing or of the installation case. On the other hand, also the household appliance may be configured to receive any module or component during an assembly movement, notably by an assembly robot moving and mounting said module or component, which is executed at least approximately orthogonally to a base area or reference area of the household appliance. In particular, the base area or the reference area of the housing or of the installation case is at least approximately horizontally aligned with a mounting surface or an assembly line in a production facility and said assembly movement is executed in a top down assembly movement, which is preferably performed until a final position of the module or component has been reached, wherein the assembly movement and/or the mounting is favourably completed by a fixing of the module or component by means of fastening means.

The household appliance is particularly a cooking appliance and may be a cooking hob, in particular an electrically driven cooking hob. A specifically selected appliance is an induction cooking hob.

The installation case may be a receptacle or compartment of the household appliance and it may be included in the housing of the household appliance. In particular, the installation case is a protection box, specifically in the example of a cooking hob.

According to an embodiment, the at least one consumer load for consumption of electrical power is any type of electrical component or electrical module with arbitrary power consumption level and/or connected value. Specifically, the at least one consumer load is at least one heating element, particularly at least one induction heating coil.

The at least one delivery system for delivery of electrical power to the at least one consumer load is in particular at least one power board, what is specifically valid for the case of a cooking hob, particularly of an induction cooking hob.

In particular, the mains connection means for a connection of the household appliance to the electric power supply is a module or component that is combined with another component or module, i. e. it may be mounted in combination with said other component or module. Preferably however, the mains connection means is a separate component or module, which is mounted during a separate mounting step, notably during an automated mounting step, preferably by means of an assembly robot. Specifically, the mains connection means is a mains terminal block.

The operating panel for appliance control and/or for user interaction is particularly a user interface. Particularly, especially in the case of a cooking hob, the operating panel is mounted in a late step of the assembling process, preferably before a mounting of a working plate of the household appliance.

The assembly movement for mounting the mains connection means and/or the control unit and/or the operating panel may be a composed movement, i.e. a series connection of a first movement in one direction and at least a second movement in another direction. However, the assembly movement is preferably a single mounting movement, namely a movement in only one direction until reaching a final assembly position.

Preferably, the at least two of, specifically at least three of or all of, the consumer load, the delivery system for electrical power, the mains connection means, the control unit and/or the operating panel are adapted to be mounted in the housing or in the installation case in consecutive mounting steps, with all mountings preferably being performed automatically, particularly by said assembly robot.

According to a specific embodiment of the invention, said connection of first and second connection means for electrical connection may be established by a separate connector element, in particular by at least one connection line which is, at least partially, included in or supported by a separate unit, which unit is connectable to a circuit board and/or to the mains connection means of the household appliance in an assembly movement mainly in a direction at least approximately orthogonally to a base area of the housing or the installation case or to a main surface of a support plate or a circuit board comprising one of the electric power delivery system or the consumer load or the mains connection means or the control unit and/or operating panel. The separate unit is preferably assembled during an automated mounting, particularly by means of said assembly robot. The separate unit may be a connection block with at least one, preferably completely, encapsulated and/or moulded cable. In particular, the assembly of the circuit board and/or the mains connection means and the assembly of the separate unit including the first one and the second one of the connection means are executed in consecutive mounting steps. More in detail, the assembling of the above-described household appliance may be realized by an assembly of a first one and, particularly subsequently, a second one of the consumer load, the delivery system, the mains connection means and the control unit and/or the operating panel, and finally an assembly of said separate connector unit.

According to a specifically preferred embodiment of the invention, the household appliance further comprises a circuit board, which comprises the delivery system for delivery of electrical power to the at least one consumer load and/or which comprises a control unit for the consumer load. Said delivery system may be a power supply means. The consumer load, which may be or may comprise a heating element, in particular an induction coil, is arranged above or below the circuit board and is electrically connected to the circuit board by means of at least one pair of connection means. Said pair of connection means comprises a first power and/or information transmitting means allocated to the consumer load and a second power and/or information transmitting means allocated to the circuit board. First and second power and/or information transmitting means are in electrical contact with each other or adapted to be put into electrical contact with each other, particularly upon impact of contact forces. Contact forces between first and second power and/or information transmitting means for providing or supporting the electrical contact are based
on elastic force acting on or coupled into at least one of the first and second power and/or information transmitting means, and/or
on force of gravity acting on or coupled into the upper one of the first and second power and/or information transmitting means, and/or
on magnetic force acting between the first and second power and/or information transmitting means, and/or
on force-fit and/or on form-fit and/or on frictionally engaged connection between the first and second power and/or information transmitting means.

If an elastic force is intended to act, said elastic force may be provided by a spring element arranged between the first and the second power and/or information transmitting means. The spring element may be supported by and/or may rest against a stationary supporting area or supporting point with a first end or first lay-on surface thereof, and a second end or a second lay-on surface of the spring element may act on or may be coupled into one of the first and second power and/or information transmitting means. Preferably, the stationary supporting area or supporting point is arranged on or rigidly connected with the other one of the first and second power and/or information transmitting means, and more preferably, said other one of the first and second power and/or information transmitting means is rigidly fixed to a housing or an installation case of the household appliance. The spring element is particularly a coil spring having a central axis, which may be oriented orthogonally to a contact or transition surface between first and second power and/or information transmitting means.

Particularly, a bolted connection between first and second power and/or information transmitting means is provided, which may be realized by a bolt or screw that is movably arranged in a slotted hole. In this case a step for the execution of the bolted connection may be included, which may be separated from and particularly following the step of arrangement or installation of the consumer load and the circuit board in a housing or an installation case of the household appliance. The bolted connection may be executed during an automated step, particularly by means of an assembly robot.

Preferably, the electrical connection between the consumer load and the circuit board is performed or performable during an assembly movement mainly in a direction at least approximately orthogonally to the main surface of the circuit board. An even more preferred embodiment provides an electrical connection, which is performed simultaneously with said assembly movement. Insofar, the provision of contact may be performed during the same movement, particularly at the end thereof.

According to an embodiment, the first power and/or information transmitting means extends downwards from a bottom side of the consumer load and the second power and/or information transmitting means extends upwards from a top side of the circuit board. In that, the first and second power and/or information transmitting means may be arranged facing each other before a connection may be established. An alternative solution to this embodiment provides that the first power and/or information transmitting means extends upwards from a top side of the consumer load and the second power and/or information transmitting means extends downwards from a bottom side of the circuit board, in that specifically also facing each other. Which one of these two solutions as described before may be used in the household appliance, depends on the respective position relative to each other the consumer load and the circuit board are occupying.

Generally, in order to provide for a specific flexibility, the circuit board may be designed in such a way that electrical connection with the first and second power and/or information transmitting means is arrangeable at two opposite sides thereof, which opposite sides may mean a top side and a bottom side or e. g. a left side and a right side thereof. Such design allows electrical connection independently of the individual positions of a first and a second circuit board relative to each other.

A first one of the first and second power and/or information transmitting means may comprise a stationary contact face and a second one of the first and second power and/or information transmitting means may comprise a movable contact face, which is a counter face to the stationary contact face. Said movable contact face may be spring-loaded and/or may be movable orthogonally to a contact area between stationary and movable contact faces. Favourably, the first and second power and/or information transmitting means, in particular the first one comprising a stationary contact face, may be supported by a housing or an installation case, either directly supported, or alternatively supported by the circuit board, which itself may be supported by the housing or installation case.

According to embodiments, the first or the second power and/or information transmitting means is a plunger or a punch, which may comprise a basically T-shaped main body. In this case, the plunger or punch, preferably a stem or base thereof, may be movably arranged at and in electrical connection with the first or the second power and/or information transmitting means. In a specific solution, the plunger or punch, preferably the stem or base thereof, may form the first or the second power and/or information transmitting means. Preferably, the plunger or punch is slidably supported in a guiding hole. Furthermore, the plunger or punch may contact a ladle- or pan-shaped socket, forming the counterpart, i.e. the other one of the first and second power and/or information transmitting means. Alternatively, the plunger or punch, or the ladle- or pan-shaped socket, respectively, may be rigidly coupled to the first or to the second power and/or information transmitting means or, respectively, to the consumer load or to the circuit board. The spring element, particularly the coil spring, may be wrapped around the plunger or punch, particularly around its stem or base. In a specific embodiment, the plunger or punch is a positioning means for the consumer load. Moreover, an advanced embodiment provides a spring that is used for electrical connection.

One specific embodiment is characterized by a first one of the first and second power and/or information transmitting means, which comprises an elongated and/or stamp-shaped contact element, and by a second one of the first and second power and/or information transmitting means, which comprises a gutter-shaped or trough-shaped contact element. The elongated and/or stamp-shaped contact element is preferably adapted to move around within the gutter-shaped or trough-shaped contact element with at least one degree of freedom. Specifically, the electrical connection by first and second power and/or information transmitting means is designed as comprising an elongated connection bar, in particular an elongated terminal bus.

Advantageously, the first and second power and/or information transmitting means enable a spatial allocation between the consumer load and the circuit board with a flexibility in one, two or three coordinate directions. In this way inevitable tolerances during the assembly of a household appliance can be compensated and the risk of contacting problems can be highly reduced.

However, in order to avoid exceptional impreciseness in mutual assignment, centering means, particularly centering bolts and respective centering holes, may be included in the circuit boards and/or modules and/or components, in particular in the first and second power and/or information transmitting means.

According to embodiments, electrical insulation between the circuit board and a terminal point of the first and second power and/or information transmitting means is provided. Said terminal point is preferably arranged at a contacting area of the consumer load.

In the case of connecting a consumer load e.g. to a power supply unit, said consumer load is particularly included in a component housing or supported by a component carrier. Then, a terminal connection, in particular a connection cable, may penetrate said component housing, e.g. a housing base part, or said component carrier for enabling establishment of connection. Particularly, a terminal point is arranged below the housing base part or component carrier, preferably by interposing an electrical insulation layer.

A further particularly specific embodiment of the present invention provides a household appliance, which further comprises a carrier plate that is arranged beneath the consumer load and that may support the consumer load. The consumer load is electrically connected to a delivery system for delivery of electrical power, in particular a power supply unit, and/or to a control unit of the household appliance by means of at least one connection means or connection line for transmission of electrical power and/or information. Said delivery system for delivery of electrical power and/or the control unit is or are arranged at least partially beneath the carrier plate. The electrical connection is established using an upper connector means arranged on an upper side of the carrier plate and a lower connector means arranged on a lower side of the carrier plate. Said upper connector means and lower connector means are electrically connected or connectable with each other through a cut-out in the carrier plate. The information to be transmitted may be any kind of electric signal, e.g. a low-voltage signal, which may include control signal such as temperature signals or illumination control, particularly for signal indication.

The consumer load is preferably at least one heating unit including at least a heating element. Advantageously, said heating unit or element, in particular its electrical connection, can be standardized, as it is not dependent from a specific arrangement in relation to a power supply unit and/or to a control unit the heating unit or element has to be connected to, which might differ amongst different household appliance models. Current designs, i.e. without such standardization, are characterized by heating units or elements with connection cables, with their lengths presently being depending on the related appliance model and/or on the installation location of the heating unit or element in one and the same appliance model. This may also mean that if at least two heating units or elements are mounted in a household appliance, by means of the invention component groups can be standardized. Particularly, in further developing the present invention, cable routing and/or cable fixation can be standardized with the advantage that electromagnetic interference (EMI) variations over different model ranges can be highly reduced.

The heating unit or element may be arranged beneath a worktop of the household appliance, particularly beneath a cooking worktop of the cooking hob. Preferably, the heating element is of a disk-shaped, an elliptical, a triangular, an oval or a bowl-shaped structure or shape.

According to one embodiment, contacting means of the upper connector means are coupled with contacting means of the lower connector means within the cut-out in the carrier plate. An alternative solution for such embodiment provides contacting means of the upper connector means, which penetrate or pass through the cut-out in the carrier plate for a coupling with contacting means of the lower connector means at the lower side of the carrier plate. According to yet another alternative solution for this embodiment, contacting means of the lower connector means penetrate or pass through the cut-out in the carrier plate for a coupling with contacting means of the upper connector means at the upper side of the carrier plate.

In particular, the at least one cut-out is covered by at least one of the upper connector means and the lower connector means, preferably by both the upper and the lower connector means. The coverage may be performed by a body or casing part of the upper connector means and/or of the lower connector means. In this way, the upper connector means and, preferably, the combination of upper and lower connector means, is supported by the carrier plate. Moreover, with closing the cut-out by a, preferably complete, coverage, electromagnetic emissions may be favourably reduced, which might occur due to omission of uncovered holes in coil carrier. That way, if the heating element is an induction coil, it may be arrangeable or arranged on the carrier plate, which in this example is referred to as coil carrier, without a separate coil plate under coil winding as it is usual nowadays, what means that the induction coil is directly placed on coil carrier.

Upper connector means and lower connector means may be connectable using snap elements or bayonet connection means. Preferably, at least a part of the snap elements or of the bayonet connection means engage with or penetrate the cut-out in the carrier plate. A specific embodiment is characterized by upper and lower connector means, which both include snap elements or bayonet means that interact with one another by forming a coupling connection. When coupled that way, the upper and lower connector means may sandwich the carrier plate, notably an edging of the cut-out in the carrier plate.

In order to reduce the number of assembling steps during manufacturing of the household appliance, the upper connector means is preferably connected to the heating unit, particularly to the heating element. This can create the possibility of mounting the heating unit into the housing of the household appliance by simultaneously connecting the connector means. Moreover, the connector means, in particular the upper connector means, may comprise fixation means for fixation of the heating unit, particularly of the heating element.

The upper connector means is favourably designed in two parts with a first upper connector means, which is arranged at the consumer load, particularly at the heating unit, more particularly at the heating element, and which is connectable to a second upper connector means. The second upper connector means is arranged or arrangeable at the carrier plate and directly connected or connectable to the lower connector means. In particular, the first upper connector means is rigidly connected to the heating unit, and additionally or alternatively, the second upper connecting means is rigidly connected or connectable to the carrier plate.

According to one embodiment, the second upper connector means and the lower connector means form a push-in and/or snap-fit connector for the consumer load, in particular for the heating element or heating unit. More specifically, the push-in and/or snap-fit connector may be provided for the first upper connector means arranged at the consumer load, in particular at the at the heating element or heating unit.

The lower connector means may be connected to the at least one connection line for transmission of electrical power and/or information coupled with or adapted to be coupled with the power supply unit and/or with a control unit.

According to embodiments, the household appliance includes sensor means, particularly associated to or coupled with the heating unit, e.g. to the heating element. Said sensor means may be or comprise a temperature sensor for temperature sensing and particularly for temperature control, especially for power control of the heating element. A connection line or cable for connecting the sensor means, particularly the temperature sensor, which may be included in the connection line for transmission of electrical power and/or information, may also penetrate or pass-through the cut-out in the carrier plate.

The upper connector means may comprise male connectors and the lower connector means may comprise female connectors, however, also the opposite may be realized. In principle, also a mixture of male and female connectors in the upper and lower connector means may be considered as long as the individual contacting pairs match up for establishing a connection.

The object is also achieved by a method for assembling a household appliance, which comprises the step
a. providing a housing or an installation case
and at least two of the steps
b. mounting of at least one electric power delivery system for delivery of electrical power to at least one consumer load into or on the housing or the installation case;
c. mounting of at least one consumer load for consumption of electrical power into or on the housing or the installation case;
d. mounting of a mains connection means for a connection of the household appliance to the electric power supply into or on the housing or the installation case; and
e. mounting of a control unit and/or operating panel for appliance control and/or for user interaction, particularly a user interface, into or on the housing or the installation case.

The at least two of the mounting steps b., c., d. and e. are consecutively performed in an assembly movement in a direction at least approximately orthogonally to a base area of the housing or the installation case or to a main surface of a support plate or a circuit board comprising one of the electric power delivery system or the consumer load or the mains connection means or the control unit and/or operating panel. During the second one of two consecutive mounting steps at least one first connection means for electrical connection is connected to at least one second connection means by a connection movement, which points in the same direction as or complies with the assembling movement of the second one of the two consecutive mounting movements.

The household appliance, to which the method applies or which is designed for the method to be applied on, is particularly a cooking appliance and may be a cooking hob, in particular an electrically driven cooking hob. A specifically selected appliance is an induction cooking hob. Further, it may be a household appliance according to anyone of the afore-described embodiments.

The installation case that may be provided is preferably a protection box. In particular, the at least one electric power delivery system is at least one power board. Further, the at least one consumer load is particularly at least one heating element, which specifically may be an induction heating coil. The mains connection means to be mounted may be a mains terminal block.

According to one specific embodiment of the method, the step a. is the first one of the assembling method and the at least two of the mounting steps b. to e. are performed in either order. The connection and/or assembly may be established or performed by a single movement, for example an at least approximately linear movement in one direction.

During the connection movement the at least one first connection means particularly couples to the at least one second connection means, which coupling is supported by at least one of elastic force, force of gravity, magnetic force, force-fit and/or form-fit and/or frictionally engaged connection that acts between the at least one first and second connection means.

One preferred embodiment of the present invention comprises at least the steps a. to c., wherein the mounting step c. includes either the mounting steps c1. and c2. or the mounting steps c1′. and c2′. The mounting step c1. comprises the step of mounting a carrier plate to a bottom side of the consumer load, and the mounting step c2. comprises the step of mounting the consumer load together with said carrier plate into the housing or the installation case. In the alternative, the mounting step c1′. comprises the step of mounting a carrier plate into the housing or the installation case and the mounting step c2′. comprises the step of mounting the consumer load into the housing or the installation case on the upper side of the carrier plate.

A cut-out may be implemented in the carrier plate prior to mounting step c1. or prior to mounting step c1′. Later on, an upper connector means may be arranged at the upper side of the cut-out and a lower connector means may be arranged at the lower side of the cut-out. Finally, an electrical connection may established by coupling electrical contacts arranged in the upper and lower connector means.

The lower connection means is particularly connected to the electric power delivery system, preferably prior to or during the mounting step c2. or prior to or during the mounting step c1′. Additionally or alternatively, the upper connection means may be connected to the consumer load, preferably during the mounting step c1. or during the mounting step c2′.

One particularly preferred embodiment of the method according to the invention is characterized by mounting a heating unit, particularly a heating element, on a carrier plate and electrically connecting it to a power supply means or unit. The assembling movement thereof is performed in a direction at least approximately orthogonally to the carrier plate. The electrical connection is established together with the assembling movement or, alternatively, a connection movement, at least for a final electrical connection, follows said assembling movement.

Novel and inventive features of the present invention are set forth in the appended claims.

The present invention will be described in further detail with reference to the drawing, in which

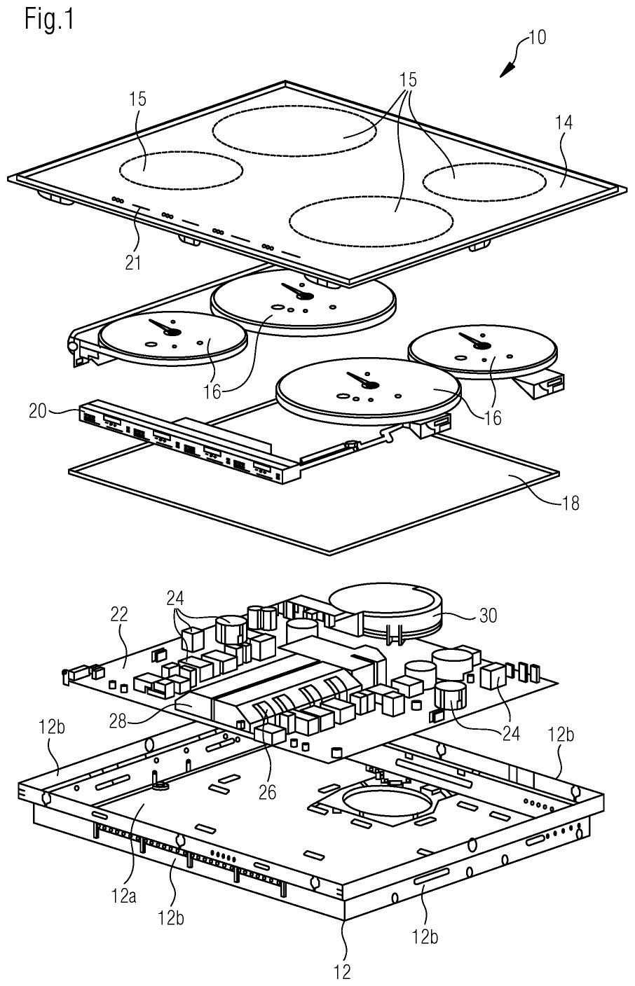

FIG. 1 illustrates the general structure of an induction cooking hob in an exploded perspective view;

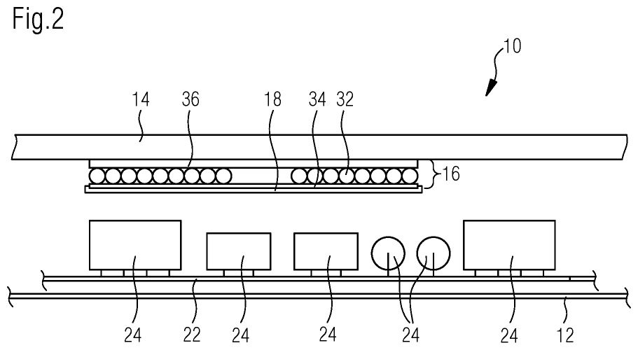

FIG. 2 is a schematic partial side view of a heating coil unit of the induction cooking hob of FIG. 1;

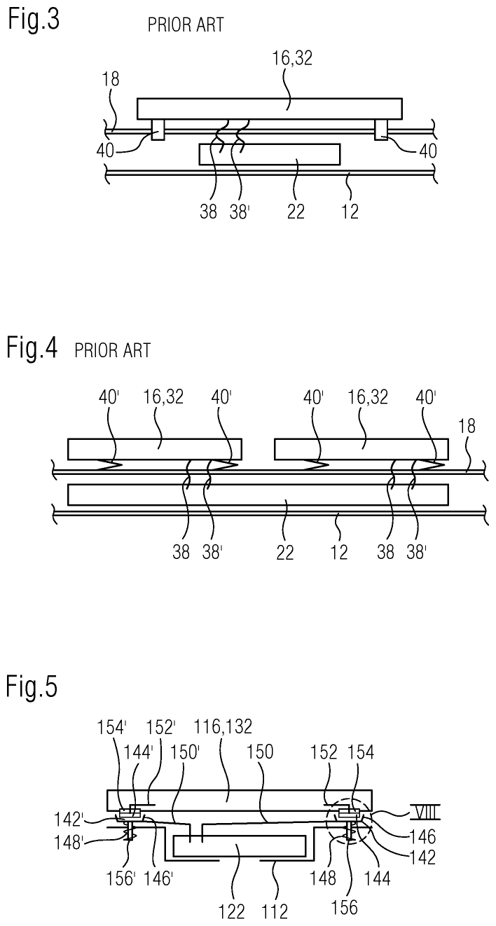

FIG. 3 illustrates schematically a front view of an electric connection of modules of an induction cooking hob according to a prior art;

FIG. 4 is a schematic side view of the induction cooking hob of FIG. 3;

FIG. 5 illustrates schematically a front view of an electric connection of modules of an induction cooking hob according to a first solution of a first embodiment of the invention;

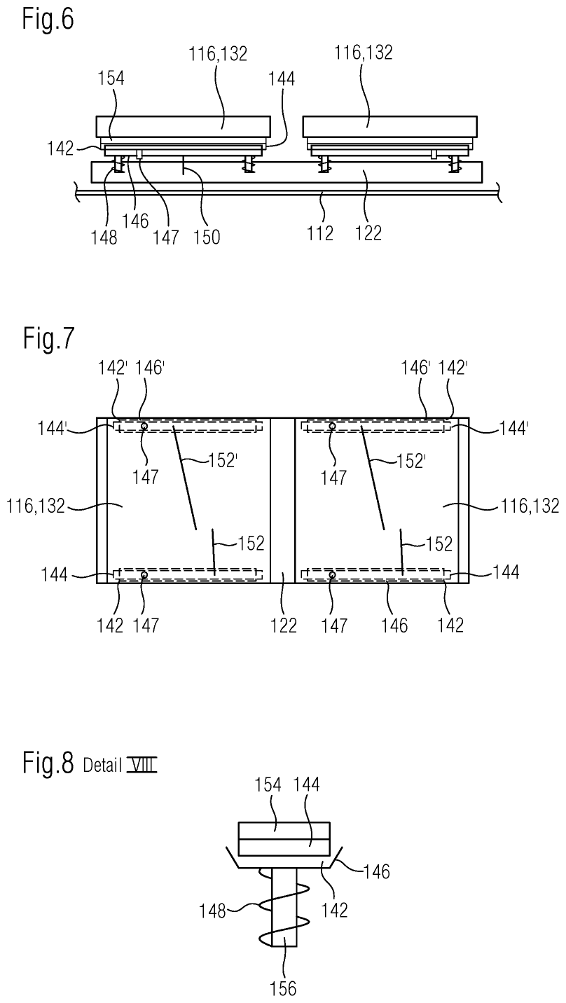

FIG. 6 is a schematic side view of the induction cooking hob of FIG. 5;

FIG. 7 is a schematic top view of the induction cooking hob of FIG. 5;

FIG. 8 illustrates a detail view of the electric connection of the induction cooking hob of FIG. 5;

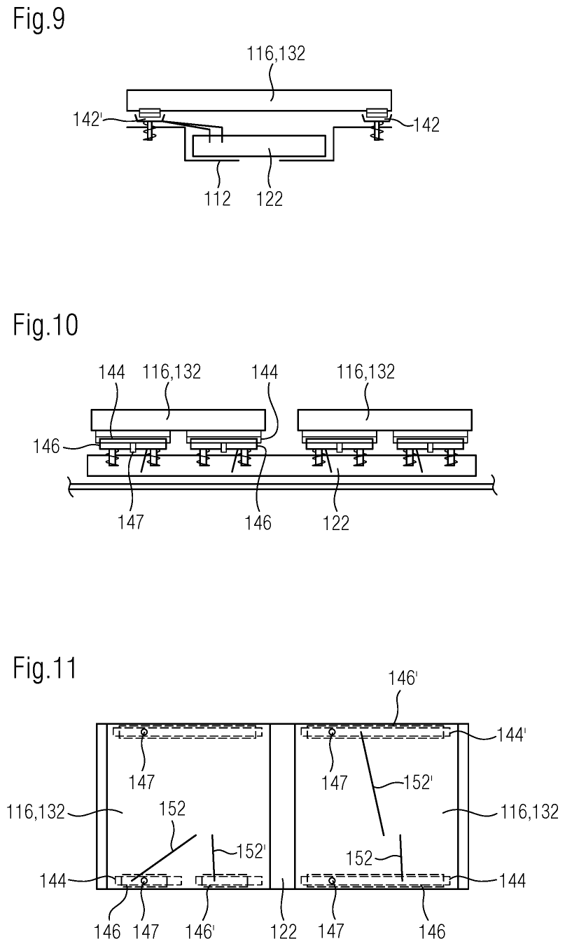

FIG. 9 illustrates schematically a front view of an electric connection of modules of an induction cooking hob according to a second solution of the first embodiment of the invention;

FIG. 10 is a schematic side view of the induction cooking hob of FIG. 9;

FIG. 11 is a schematic top view of the induction cooking hob of FIG. 9; and

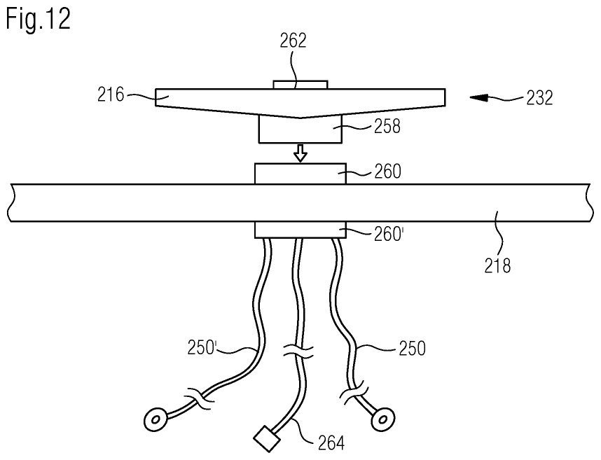

FIG. 12 illustrates schematically a side view of an electric connection of a heating coil unit of an induction cooking hob according to a second embodiment of the invention;

FIG. 1 illustrates an exploded perspective view of the general structure of a cooking hob 10.

The cooking hob 10 comprises a casing 12 and a panel 14. The casing 12 includes a bottom wall 12a, four sidewalls 12b and an open top side. Preferably, the casing 12 is made of metal, e.g. steel. Alternatively, the casing 12 may be made of plastics. The panel 14 covers the top side of the casing 12. For example, the panel 14 is a glass ceramic panel.

The cooking hob 10 comprises four circular cooking zones 15, two thereof with a smaller diameter, while the diameter of the other two cooking zones 15 are larger. The contours of the cooking zones are indicated by respective circles on the top surface of the glass panel 14. Each cooking zone 15 receives its heating power from a heating element 16 arranged beneath the panel 14.

A carrier 18 supports the heating element 16. Said carrier 18 is arranged beneath the heating elements 16. The carrier 18 is a metallic plate, preferably made of an aluminium material, and may be of an extension adapted to carry all four heating elements 16, in that having dimensions close to the dimensions of the glass panel 14. Alternatively, four carriers 18 may be provided, each carrier 18 supporting merely one dedicated heating element 16.

The cooking hob 10 further comprises a control panel 20 for controlling the cooking hob functions. The control panel 20 includes touch sensors and display means corresponding with a user interface zone 21 arranged at the front edge of the glass panel 14.

Preferably, the heating element 16 is an electric heating element. At least one printed circuit board 22 is arranged above the bottom wall 12a of the casing 12. A plurality of electric and/or electronic elements 24, 26 is attached on the printed circuit board 22. The printed circuit board 22 including the electric and/or electronic elements 24, 26 forms a power board of the cooking hob 10. Power electronic elements 26 for supplying the heating elements 16 with electrical power are attached to a cooling channel 28, which extends horizontally through the cooking hob 10. An air stream driven by at least one fan 30 passes the cooling channel 28 and cools down the power electronic elements 26.

In this example, the cooking hob 10 is an induction cooking hob, wherein the heating element 16 is a heating coil unit 16 comprising an induction coil 32 and the carrier 18 is a coil carrier.

According to FIG. 2, which shows a schematic partial side view of a heating coil unit 16 of the induction cooking hob 10 including the coil carrier 18, an optionally implemented first discoid layer 34 (not shown in FIG. 1) is arranged between the induction coil 32 acting as a spacer between the induction coil 28 and the coil carrier 18. This first layer 34 may work also as a support means for the induction coil 32.

FIG. 2 also shows a second layer 36 (not shown in FIG. 1), which is also optional and which may be arranged directly beneath the panel 14, but above the heating coil unit 16, in that separating the heating coil unit 16 from the glass panel 14. The second layer 36 provides for electrical isolation of conducting parts of the heating coil unit 16 towards panel 14. In case of the panel 14 being a glass ceramic panel, the isolating effect of such material is more and more decreasing when heated up to a temperature of more than about 400 centigrades. Then the second layer 36 more and more takes over the electrical isolation, and fully taking over when the glass ceramic temperature is exceeding 700 centigrades. In addition, the second layer 36 may work as an additional safety element against electric shocks in case of damages to the panel 14.

As indicated above, the heating energy for a cooking zone 15 of an induction cooking hob 10 is generated by means of the related induction coil 32 of the heating coil unit 16 supplied by the associated elements of the power board 22. FIGS. 3 (front view) and 4 (side view) schematically show an electrical connection between the power board 22 and induction coils 32 for power supply of the coil 32 as it is realized nowadays in common induction cooking hobs and, insofar, forming a prior art solution. According to these two illustrations, a first one and a second one of the four cooking zones 15 according to FIG. 1, each one thereof comprising a heating coil unit 16, are connected to a related first power board 22 for the power supply of the included induction coil 32. Respectively, as not illustrated, a third one and a fourth one of the four cooking zones 15 according to FIG. 1 are connected to a related second power board 22. This means that, according to the specific prior art solution of FIGS. 3 and 4, the power board 22 of FIG. 1, which supplies the induction coils 32 of all four cooking zones 15, is separated into two, preferably identically structured, power boards 22, each one thereof supplying two induction coils 32.

As also indicated by FIGS. 3 and 4, the electric connection between the power board 22 and each one of the induction coils 32 is realized by a pair of power connection cables 38, 38′, which may be fixed with their first ends to coil connections at the induction coil 32 (not shown) and which may be connected with their second ends to respective connection terminals on the power board 22, which connection is usually performed manually in an assembly line. In line with FIGS. 1 and 2, the heating coil units 16 are arranged on the coil carrier 18, which itself is supported by the casing 12 (not shown), on which casing 12 also the power board 22 rests. The heating coil units 16 may be rigidly supported by the coil carrier 18 (as indicated in FIG. 3 by 40) or they may be spring-mounted on the coil carrier 18 (as indicated in FIG. 4 by 40′) enabling a pressing of the heating coil units 16 against the glass panel 14 for a better transfer of heating energy to cookware (not shown) placed on the glass panel 14.

It is to be noted that what is described and shown with transfer of electrical power by power connection cables 38, 38′ is also valid for signal and/or information transfer, for which respective signal and/or information transfer cables are presently manually connected in an assembly line.

FIGS. 5 to 8 schematically illustrate a first solution of a first embodiment for an automated electrical connection of a heating coil unit 116 to the related power board 122. In line with the prior art solution according to FIGS. 3 and 4, two heating coil units 116, each one comprising an induction coil 132, are arranged within a casing 112 above a power board 122 that is configured to supply the induction coils 132 with electrical power. The heating coil unit 116 may be supported by a coil carrier as is the case with the prior art solution, however, as indicated by FIGS. 5 and 6, a coil carrier plate can be an integral part of the heating coil unit 116.

According to FIG. 5 (front view), FIG. 6 (side view) and FIG. 7 (top view), the heating coil unit 116, or the induction coil 132, respectively, is electrically connected to the power board 122 for power supply by means of two connection points 142, 142′. Each of the two connection points 142, 142′, one thereof being illustrated in more detail by FIG. 8, include a power transmitting bar 144, 144′ assigned to the heating coil unit 116 or the induction coil 132, respectively, and a trough-shaped power transmitting rail 146, 146′ assigned to the power board 122. Said power transmitting bars 144, 144′ are bar-shaped and fit into said power transmitting rails 146, 146′ for bipolar power transmission, wherein the lower surfaces of the power transmitting bars 144, 144′ and the upper surfaces of the power transmitting rails 146, 146′ form an elongated contact surface, which is configured to provide a low contact resistance under any circumstances, i.e. considering the full tolerance range for position assignment between power transmitting bars 144, 144′ to power transmitting rails 146, 146′. In order to adapt to manufacturing tolerances, said contact surface is characterized by sufficient clearance in two directions, i.e. the power transmitting bars 144, 144′ may slide in relation to the power transmitting rails 146, 146′ over the contact surface lengthways and sideways, however, sideways movements are limited by lateral boundaries of the power transmitting rails 146, 146′. However, in order to limit effects of manufacturing tolerances and for a more exact local association, at least a pair of bolts 147 and related positioning holes are provided, one thereof being positioned at the heating coil unit 116 and the other one thereof being positioned at the power board 122.

For an even further decreased contact resistance the power transmitting rails 146, 146′ are pressed against the allocated power transmitting bars 144, 144′, which themselves are stationarily positioned, since movement of the heating coil units 116 is limited in upward direction by the stationary panel 14. This pressure between power transmitting rails 146, 146′ and power transmitting bars 144, 144′ is applied by spring forces coming from spiral springs 148, 148′ pushing up the power transmitting rails 146, 146′ against the assigned power transmitting bars 144, 144′.

The power transmitting bars 144, 144′ are connected to respective terminal points of the power board 122 by means of first power cords 150, 150′ and the power transmitting rails 146, 146′ are connected to respective terminal points of the induction coil 132 by means of second power cords 152, 152′. Except for the second power cords 152, 152′, the power transmitting bars 144, 144′ are electrically isolated from the heating coil unit 132 by means of electrical insulation layers 154, 154′.

According to the present example, the power transmitting rails 146, 146′ are supported by two columns 156, 156′, which are directed downwards from a bottom side of the power transmitting rails 146, 146′ and which are slidably mounted in related seats at the casing 112 (see FIG. 5) or at the power board 122 (see FIG. 6). Other examples may be designed with more than two columns or other support means. As can be best seen in FIG. 8, the spiral springs 148, 148′ are wrapped around and in this way kept in place by the columns 156, 156′. Said spiral springs 148, 148′ are supported by an upper surface of the casing 112 or, alternatively, of the power board 122.

The heating coil units 116 and the related power transmitting bars 144, 144′ on the one hand and the power board 122 and the related power transmitting rails 146, 146′ on the other hand are two separate assembly groups, which may be pre-mounted independently from each other and assembled and interconnected in the assembly line. Said assembling and interconnection is preferably performed automatically by an assembly robot that at first integrates the power board 122 together with the power transmitting rails 146, 146′ into the housing or casing 112 of the cooking hob 10, particularly by a top down assembly movement, and that thereafter integrates the heating coil units 116 together with the related power transmitting bars 144, 144′ into the housing or casing 112 of the cooking hob 10 on top of the power board assembly group, particularly also by a top down assembly movement, thereby also establishing the electrical connection by bringing the power transmitting bars 144, 144′ and the power transmitting rails 146, 146′, particularly pairwise, into connection with each other.

In FIGS. 9 to 11 a second solution for the first embodiment for an automated electrical connection of a heating coil unit 116 to the related power board 122 is shown. This second solution is very similar to the first solution as far as the involved assembly groups with the heating coil unit on the one hand and the power board on the other hand as well as related connecting points 142, 142′, i.e. the power transmitting bars 144, 144′ and the power transmitting rails 146, 146′, and the assembling of these assembly groups are concerned. The first and second solutions only differ in the arrangement of the pairs of power transmitting bars 144, 144′ and the power transmitting rails 146, 146′ in a row on the same side of the power board 122 and, respectively, of the heating coil unit 116, as illustrated with the left pair of assembly groups in FIGS. 10 and 11. The right pair of assembly groups in these figures may be designed in the same way, or, as illustrated, by using the first solution, which is characterized by the pairs of power transmitting bars 144, 144′ and the power transmitting rails 146, 146′ being arranged in parallel on opposite sides of the power board 122 and, respectively, of the heating coil unit 116.

An embodiment, which is not shown in the drawings, but which may be implemented in anyone of the solutions described before, may provide for a power board 122 that, additionally or alternatively to the power transmitting rails 146, 146′, is arranged within the casing 112 in a spring-loaded manner. Moreover, the same or another embodiment may provide for heating coil units 116 that are pressed against the panel 14, which contact pressure may also be performed by the spiral springs 148, 148′.

The above-described solutions only show and describe power transmission by means of pairs or couples of power transmitting bars 144, 144′ and the power transmitting rails 146, 146′. However, this kind of electrical connection may also be used in the same or in a similar way for signal and/or information transfer. In that case, the connection couples may be designed as information transmitting bars and information transmitting rails. Also combined solutions of power transmitting rails and information transmitting rails as well as of power transmitting bars and information transmitting bars are considerable.

FIG. 12 illustrates a second embodiment for an automated electrical connection of a heating coil unit 216 to the related power board (not shown in FIG. 12). A heating coil unit 216 comprising an induction coil 232 is arranged within a casing (not shown in FIG. 12) above a power board that is configured to supply the induction coil 232 with electrical power. The heating coil unit 216 is supported by a coil carrier 218, which itself may be supported by the casing or by the power board.

The heating coil unit 216 includes connection means at least for establishing an electrical connection at least for providing a power supply to the induction coil 232. Said connection means comprises a snap-fit plug 258 including electrical connection terminals or poles (not shown) that are coupled with a coil winding (not shown), which terminals or poles are arranged within a plug housing and which are not shown in detail. Said snap-fit plug 258 and its electrical connection terminals or poles are complementary elements to a respective snap-fit socket 260, 260′ that also includes electrical connection terminals or poles (not shown). The terminals or poles of the snap-fit plug 258 on the one hand and the terminals or poles of the snap-fit socket 260, 260′ on the other hand are provided for establishing an electrical connection, particularly at least for a connection of the heating coil unit 216 and its included induction coil to the power board. In addition, the housing of the snap-fit plug 258 and a housing of the snap-fit socket 260, 260′ are provided for a mechanical connection, preferably a snap-fit connection.

Since the power board is arranged beneath the coil carrier 218, the electrical connection has to pass through a respective opening in the coil carrier 218. Known solutions are designed by a manual threading of connection cables, particularly of power cords, connected to the heating coil unit 216 through said opening, which threading and connection to the power board has to be performed before the coil carrier 218 is finally mounted, whereas the present solution according to FIG. 12 is characterized by a separation of the power cords 250, 250′, which are provided for being connected to the power board, from the heating coil unit 216. Instead, the power cords 250, 250′ are solely arranged on the underside of the coil carrier 218 and destined to be connected to respective terminals at the power board independently from an assembling of the heating coil unit 216. That way, the coil carrier and the power cords 250, 250′ form an independently mountable assembly unit.

The coupling of the snap-fit plug 258 with the snap-fit socket 260, 260′ is performed in conjunction with the assembly of the heating coil unit 216 (see arrow in FIG. 12), which leads to both electrical and mechanical connection. Said electrical connection establishes the electric power supply of the induction coil 232 sourcing from the power board.

As illustrated by FIG. 12, the snap-fit socket is constructed as a two-part solution comprising a top snap-fit socket part 260 arranged or arrangeable on a top side of the coil carrier 218 and a bottom snap-fit socket part 260′ arranged or arrangeable on a bottom side of the coil carrier 218. The two parts are merged to form the snap-fit socket 260, 260′ through the related connection hole in the coil carrier 218 by means of a snap-fit connection establishing both a mechanical and an electrical connection between these two parts 260, 260′.

The second embodiment according to FIG. 12 is of advantage in comparison to known solutions, as it provides a standardization of heating element models, because for different cooking hobs a standardized heating coil unit 216 is useable. There is no longer a provision of different power supply cables needed with such a standardized heating coil unit 216. Such kind of standardization reduces costs in a manufacturing plant for cooking hobs. Another advantage over known solutions is the coverage of the connection hole by at least one of the housings of top and bottom snap-fit socket parts 260, 260′. Due to said coverage no holes are present in the coil carrier 218, what keeps electromagnetic emissions within limits. Yet another advantage is the automated assembly of the cooking hob by means of an assembly robot. Said automated assembly comprises the consecutive manufacturing steps of
providing a cooking hob housing, particularly a protection box
mounting of the power board into the housing
connecting the power cords 250, 250′ to respective terminals on the power board
mounting of the coil carrier 218 into the housing
mounting of the at least one heating coil unit into the housing by electrically and mechanically coupling the snap-fit plug 258 with the snap-fit socket 260, 260′.

Finally, the solution according to FIG. 12 is also characterized in that the assembling unit that includes the heating coil unit 216 also comprises a temperature sensor 262 for a control and/or security monitoring of the temperature prevailing in the region above the heating coil unit 216. The temperature signal is transmitted by cable connection to a control unit (not shown) in the same way as the power supply, namely through the snap-fit plug 258 and the snap-fit socket 260, 260′ and by means of a signal cable 264 connected to a terminal at the bottom snap-fit socket part 260′.

### LIST OF REFERENCE NUMERALS

10 cooking hob
12,112 casing
12a bottom wall
12b side walls
14 glass panel
15 cooking zones
16,116,216 heating coil units
18,218 coil carrier
20 control panel
21 user interface zone
22,122 power board
24,26 electric/electronic elements
28 cooling channel
30 fan
32,132,232 induction coil
34,36 first and second layers
38,38′ power connection cables
40 rigid support
40′ spring-mounted support
142,142′ connection points
144,144′ power transmitting bars
146,146′ power transmitting rails
147 bolts
148,148′ spiral springs
150,150′,250,250′ first power cords
152,152′ second power cords
154,154′ insulation layers
156,156′ columns
258 snap-fit plug
260,260′ top and bottom snap-fit socket parts
262 temperature sensor
264 signal cable

1. A household appliance, comprising:
a housing or an installation case;
at least two of the following:
a consumer load for consumption of electrical power, being or comprising heating element,
a power board for delivery of electrical power to the at least one consumer load,
a mains terminal block for a connection of the household appliance to an electric power supply,
a user interface for appliance control and/or for user interaction; and
at least one connection means for electrical connection of at least two of:
the consumer load,
the power board for electrical power,
the mains terminal block,
the user interface;
wherein the at least two of:
the consumer load,
the power board for electrical power,
the mains terminal block,
the user interface;
are arranged or arrangeable within the housing or installation case in superimposed levels,
and wherein at least one of:
the consumer load,
the power board for electrical power,
the mains terminal block,
the user interface;
comprises a first connection means for electrical connection, which is connectable to a second connection means for electrical connection, the second connection means being arranged or having been arranged in the housing or installation case, in a connection movement, which points in a same direction as or complies with an assembly movement for assembling the at least one of:
the consumer load,
the power board for electrical power,
the mains terminal block,
the user interface;
in the housing or installation case, which connection and/or assembly movement is a single movement.

2. The household appliance according to claim 1,
wherein the consumer load is arranged above or below the power board and is electrically connected to the power board by at least one pair of connection means comprising a first power and/or information transmitting means allocated to the consumer load and a second power and/or information transmitting means allocated to the power board, wherein contact forces between the first and second power and/or information transmitting means are based:
on elastic force acting on or coupled into at least one of the first and second power and/or information transmitting means, and/or
on force of gravity acting on or coupled into an upper one of the first and second power and/or information transmitting means, and/or
on magnetic force acting between the first and second power and/or information transmitting means, and/or
on force-fit and/or on form-fit and/or on frictionally engaged connection between the first and second power and/or information transmitting means.

3. The household appliance according to claim 2, wherein the electrical connection between the consumer load and the circuit board is performed or performable during an assembly movement mainly in a direction at least approximately orthogonally to a main surface of the power board.

4. The household appliance according to claim 2, wherein the first power and/or information transmitting means extends downwards from a bottom side of the consumer load and the second power and/or information transmitting means extends upwards from a top side of the power board, or
the first power and/or information transmitting means extends upwards from a top side of the consumer load and the second power and/or information transmitting means extends downwards from a bottom side of the power board.

5. The household appliance according to claim 2, wherein a first one of the first and second power and/or information transmitting means comprises a stationary contact face and a second one of the first and second power and/or information transmitting means comprises a spring-loaded movable contact face being a counter face to the stationary contact face, the movable contact face being movable orthogonally to a contact area between the stationary and movable contact faces.

6. The household appliance according to claim 2, wherein a first one of the first and second power and/or information transmitting means comprises an elongated and/or stamp-shaped contact element and a second one of the first and second power and/or information transmitting means comprises a gutter-shaped or trough-shaped contact element, the elongated and/or stamp-shaped contact element being adapted to move around within the gutter-shaped or trough-shaped contact element with at least one degree of freedom.

7. The household appliance according to claim 2, wherein the first and second power and/or information transmitting means enable a spatial allocation between the consumer load and the power board with a flexibility in one, two or three coordinate directions.

8. The household appliance according to claim 1, further comprising a carrier plate arranged beneath and supporting the consumer load, which consumer load is electrically connected to the power board by the at least one connection means, wherein the power board and/or the user interface is/are arranged at least partially beneath the carrier plate, wherein the electrical connection is established using an upper connector means arranged on an upper side of the carrier plate and a lower connector means arranged on a lower side of the carrier plate, which upper connector means and lower connector means are electrically connected or connectable with each other through a cut-out in the carrier plate, and wherein the heating element is arranged beneath a worktop of the household appliance.

9. The household appliance according to claim 8, wherein the upper connector means are coupled with the lower connector means within the cut-out in the carrier plate, or
the upper connector means penetrate or pass through the cut-out in the carrier plate for a coupling with the lower connector means at the lower side of the carrier plate, or
the lower connector means penetrate or pass through the cut-out in the carrier plate for a coupling with the upper connector means at the upper side of the carrier plate.

10. The household appliance according to claim 8, wherein the cut-out is covered by at least one of the upper connector means and the lower connector means, by a body or casing part thereof.

11. The household appliance according to claim 8, wherein the upper connector means and the lower connector means are connectable by snap elements or via bayonet connection elements, at least a part of the snap elements or the bayonet connection elements engaging with or penetrating the cut-out in the carrier plate.

12. The household appliance according to claim 8, wherein the upper connector means comprises two parts with a first upper connector means, which is arranged at the heating element, and which is connectable to a second upper connector means, the second upper connector means being arranged or arrangeable at the carrier plate and directly connected or connectable to the lower connector means.

13. The household appliance according to claim 12, wherein the second upper connector means and the lower connector means form a push-in and/or snap-fit connector for the heating element, the push-in and/or snap-fit connector being provided for the first upper connector means arranged at the heating element.

14. The household appliance according to claim 8, wherein the lower connector means is connected to a connection line for transmission of electrical power and/or information, which connection line for transmission of electrical power and/or information is coupled with or adapted to be coupled with the power board and/or with the user interface.

15. A method for assembling a household appliance, comprising the steps of:
a. providing a housing or an installation case,
and at least two of the following steps:
b. mounting of a power board for delivery of electrical power to a consumer load into the housing or the installation case;
c. mounting the consumer load into the housing or the installation case, the consumer load comprising a heating element;
d. mounting of a mains terminal block for a connection of the household appliance to an electric power supply into or on the housing or the installation case; and
e. mounting of a user interface for appliance control and/or for user interaction into or on the housing or the installation case;
wherein at least two of the steps b., c., d. and e. are consecutively performed in an assembly movement in a direction at least approximately orthogonally to a base area of the housing or the installation case or to a main surface of a support plate or a circuit board comprising the power board or the consumer load or the mains terminal block or the user interface,
and wherein during the second one of two consecutive mounting steps at least one first connection means for electrical connection is connected to at least one second connection means with a connection movement, which points in the same direction as or complies with the assembling movement of the second one of the two consecutive mounting movements.

16. The method according to claim 15, wherein the at least two of the steps b. to e. are performed in either order and the connection movement and/or the assembly movement is/are a single movement/single movements.

17. The method according to claim 15, wherein during the connection movement the at least one first connection means couples to the at least one second connection means, which coupling is supported by:
elastic force and/or
force of gravity and/or
magnetic force and/or
force-fit and/or form-fit and/or frictionally engaged connection acting between the at least one first and second connection means.

18. The method according to anyone of the claim 15, comprising at least the steps a. to c., wherein the mounting step c. includes either mounting steps c1. and c2. or mounting steps c1′. and c2′., wherein:
the mounting step c1. comprises the step of mounting a carrier plate to a bottom side of the consumer load, and
the mounting step c2. comprises the step of mounting the consumer load together with said carrier plate into the housing or the installation case;
the mounting step c1′. comprises the step of mounting the carrier plate into the housing or the installation case, and
the mounting step c2′. comprises the step of mounting the consumer load into the housing or the installation case on an upper side of the carrier plate.

19. The method according to claim 18, wherein:
a cut-out is implemented in the carrier plate prior to mounting step c1. or prior to mounting step c1′.,
an upper connector means is arranged at an upper side of the cut-out and a lower connector means is arranged at a lower side of the cut-out, and
an electrical connection is established by coupling electrical contacts arranged in the upper and lower connector means.

20. The method according to claim 19, wherein the lower connection means is connected to the power board prior to or during the mounting step c2. or prior to or during the mounting step c1′.,
and/or
the upper connection means is connected to the consumer load during the mounting step c1. or during the mounting step c2′.
